(19) United States
(12) Patent Application Publication
(10) Pub. No.: US 2024/0296728 A1
(43) Pub. Date: Sep. 5, 2024

(54) EAR-WEARABLE DEVICES FOR IDENTIFICATION OF BALANCE CHALLENGES AT LOCATIONS

(71) Applicant: Starkey Laboratories, Inc., Eden Prairie, MN (US)

(72) Inventors: Paul Shriner, Hopkins, MN (US); Gregory John Haubrich, Champlin, MN (US)

(21) Appl. No.: 18/587,085

(22) Filed: Feb. 26, 2024

Related U.S. Application Data
(60) Provisional application No. 63/449,098, filed on Mar. 1, 2023.

(51) Int. Cl. G08B 21/04; G08B 25/01; G08B 31/00

(52) U.S. Cl. CPC G08B 21/043; G08B 21/0423; G08B 21/0446; G08B 21/0469; G08B 21/0492; G08B 25/016; G08B 31/00

(57) ABSTRACT

Embodiments herein relate to personal safety monitoring systems and/or ear-wearable devices that can be used to identify locations associated with balance challenges. In an embodiment, a personal safety monitoring system is included having a wearable device. The wearable device can include a control circuit, a motion sensor, and a wireless signal receiver. The personal safety monitoring system can be configured to detect loss of balance events and determine physical location correlated with detected loss of balance events and log the same. Other embodiments are also included herein.

This application claims the benefit of U.S. Provisional Application No. 63/449,098 filed Mar. 1, 2023, the content of which is herein incorporated by reference in its entirety.

### FIELD

Embodiments herein relate to personal safety monitoring systems and ear-wearable devices. More specifically, embodiments herein relate to systems and devices that can be used to identify locations associated with balance challenges.

### BACKGROUND

Maintaining postural control and preventing a fall are important for all people, but of special importance for the elderly. Falls are the second leading cause of accidental or unintentional injury deaths worldwide. In some cases, falls may occur because of a sudden loss of postural equilibrium occurring during normal daily activities such as rising from a chair or climbing or descending stairs. In some cases, falls may occur because of external factors such as tripping over something or slipping on something. Various health-related conditions can increase the chances that an initial loss of balance will result in a fall occurring such as weak muscles, poor balance, dizziness, fainting, cognitive problems, intoxication, infections, medication side effects, foot or leg problems, vision or hearing problems, and the like.

### SUMMARY

Embodiments herein relate to systems and devices that can be used to identify locations associated with balance challenges. In a first aspect, a personal safety monitoring system can be included including a wearable device. The wearable device can include a control circuit, a motion sensor, and a wireless signal receiver. The personal safety monitoring system can be configured to detect loss of balance events, and determine physical location correlated with detected loss of balance events and log the same.

In a second aspect, in addition to one or more of the preceding or following aspects, or in the alternative to some aspects, the personal safety monitoring system can be configured to provide a notification of physical locations associated with loss of balance events.

In a third aspect, in addition to one or more of the preceding or following aspects, or in the alternative to some aspects, the notification includes a warning of danger and the notification can be delivered prior to encountering and/or reencountering the physical location.

In a fourth aspect, in addition to one or more of the preceding or following aspects, or in the alternative to some aspects, the notification includes a warning of danger and the notification can be delivered when approaching the physical location.

In a fifth aspect, in addition to one or more of the preceding or following aspects, or in the alternative to some aspects, the personal safety monitoring system can be configured to classify the determined physical location as being a perpetual or transient danger.

In a sixth aspect, in addition to one or more of the preceding or following aspects, or in the alternative to some aspects, the personal safety monitoring system can be configured to provide a notification of physical locations associated with loss of balance events to a third party.

In a seventh aspect, in addition to one or more of the preceding or following aspects, or in the alternative to some aspects, the third party can include at least one selected from the group consisting of a care provider, a clinician, and a third-party device wearer.

In an eighth aspect, in addition to one or more of the preceding or following aspects, or in the alternative to some aspects, the personal safety monitoring system can be configured to provide suggestions to a caregiver regarding physical locations creating fall risk danger.

In a ninth aspect, in addition to one or more of the preceding or following aspects, or in the alternative to some aspects, the wireless signal receiver can include at least one selected from the group consisting of a BLUETOOTH component, an RFID component, an NFC component, a WIFI component, a geolocation system component, an electromagnetic sensor, an optical sensor, an RF indoor navigation and positioning system component, and a beacon signal receiver.

In a tenth aspect, in addition to one or more of the preceding or following aspects, or in the alternative to some aspects, loss of balance events can be detected based on motion sensor signals crossing a threshold value of variance.

In an eleventh aspect, in addition to one or more of the preceding or following aspects, or in the alternative to some aspects, the wearable device can further include a microphone.

In a twelfth aspect, in addition to one or more of the preceding or following aspects, or in the alternative to some aspects, loss of balance events can be detected based on at least one of the microphone signals and the motion sensor signals.

In a thirteenth aspect, in addition to one or more of the preceding or following aspects, or in the alternative to some aspects, the personal safety monitoring system can be configured to calculate balance recovery metrics after detected loss of balance events.

In a fourteenth aspect, in addition to one or more of the preceding or following aspects, or in the alternative to some aspects, the balance recovery metrics can include a balance recovery time.

In a fifteenth aspect, in addition to one or more of the preceding or following aspects, or in the alternative to some aspects, detected loss of balance events can be unprompted.

In a sixteenth aspect, in addition to one or more of the preceding or following aspects, or in the alternative to some aspects, detected loss of balance events can be in response to a prompt or challenge.

In a seventeenth aspect, in addition to one or more of the preceding or following aspects, or in the alternative to some aspects, the personal safety monitoring system can be configured to correlate medication administration times with detected loss of balance events.

In an eighteenth aspect, in addition to one or more of the preceding or following aspects, or in the alternative to some aspects, the personal safety monitoring system can be configured to correlate time of day with detected loss of balance events.

In a nineteenth aspect, in addition to one or more of the preceding or following aspects, or in the alternative to some aspects, the personal safety monitoring system can be configured to correlate occurrences of a daily event with detected loss of balance events.

In a twentieth aspect, in addition to one or more of the preceding or following aspects, or in the alternative to some aspects, the daily event can include at least one selected from the group consisting of a bed time, a rising time, a meal time, and a bathroom time.

In a twenty-first aspect, in addition to one or more of the preceding or following aspects, or in the alternative to some aspects, the personal safety monitoring system can be configured to detect vertical movement and correlate the same with detected loss of balance events.

In a twenty-second aspect, in addition to one or more of the preceding or following aspects, or in the alternative to some aspects, the vertical movement can include climbing stairs.

In a twenty-third aspect, in addition to one or more of the preceding or following aspects, or in the alternative to some aspects, the vertical movement can include rising from a chair.

In a twenty-fourth aspect, in addition to one or more of the preceding or following aspects, or in the alternative to some aspects, the personal safety monitoring system can be configured to calculate a trend in detected loss of balance events over time.

In a twenty-fifth aspect, in addition to one or more of the preceding or following aspects, or in the alternative to some aspects, the personal safety monitoring system can be configured to classify the severity of the detected loss of balance events.

In a twenty-sixth aspect, in addition to one or more of the preceding or following aspects, or in the alternative to some aspects, the personal safety monitoring system can be configured to calculate a trend in the severity of loss of balance events over time.

In a twenty-seventh aspect, in addition to one or more of the preceding or following aspects, or in the alternative to some aspects, the wearable device can be an ear-wearable device.

In a twenty-eighth aspect, in addition to one or more of the preceding or following aspects, or in the alternative to some aspects, the wearable device can be a hearing assistance device.

In a twenty-ninth aspect, in addition to one or more of the preceding or following aspects, or in the alternative to some aspects, the personal safety monitoring system can be configured to detect loss of balance events within a home environment.

In a thirtieth aspect, in addition to one or more of the preceding or following aspects, or in the alternative to some aspects, the personal safety monitoring system can be configured to detect loss of balance events within a work environment.

In a thirty-first aspect, in addition to one or more of the preceding or following aspects, or in the alternative to some aspects, the personal safety monitoring system can be configured to detect loss of balance events within an out-of-home activity environment.

In a thirty-second aspect, in addition to one or more of the preceding or following aspects, or in the alternative to some aspects, the wearable device can further include a clock circuit.

In a thirty-third aspect, in addition to one or more of the preceding or following aspects, or in the alternative to some aspects, the personal safety monitoring system can further include a second wearable device. The second wearable device can include a second control circuit, a second motion sensor, and a second wireless signal receiver. The personal safety monitoring system can be configured to detect loss of balance events using signals from both the wearable device and the second wearable device.

In a thirty-fourth aspect, an ear-wearable device system can be included having an ear-wearable device. The ear-wearable device can include a control circuit, a motion sensor, and a wireless signal receiver. The ear-wearable device system can be configured to detect loss of balance events and determine physical location correlated with detected loss of balance events and log the same.

In a thirty-fifth aspect, in addition to one or more of the preceding or following aspects, or in the alternative to some aspects, the ear-wearable device system can be configured to provide a notification of physical locations associated with loss of balance events.

In a thirty-sixth aspect, in addition to one or more of the preceding or following aspects, or in the alternative to some aspects, the notification includes a warning of danger and the notification can be delivered prior to encountering and/or reencountering the physical location.

In a thirty-seventh aspect, in addition to one or more of the preceding or following aspects, or in the alternative to some aspects, the notification includes a warning of danger and the notification can be delivered when approaching the physical location.

In a thirty-eighth aspect, in addition to one or more of the preceding or following aspects, or in the alternative to some aspects, the ear-wearable device system can be configured to classify the determined physical location as being a perpetual or transient danger.

In a thirty-ninth aspect, in addition to one or more of the preceding or following aspects, or in the alternative to some aspects, the ear-wearable device system can be configured to provide a notification of physical locations associated with loss of balance events to a third party.

In a fortieth aspect, in addition to one or more of the preceding or following aspects, or in the alternative to some aspects, the third party can include at least one selected from the group consisting of a care provider, a clinician, and a third party device wearer.

In a forty-first aspect, in addition to one or more of the preceding or following aspects, or in the alternative to some aspects, the ear-wearable device system can be configured to provide suggestions to a caregiver regarding physical locations creating fall risk danger.

In a forty-second aspect, in addition to one or more of the preceding or following aspects, or in the alternative to some aspects, the wireless signal receiver can include at least one selected from the group consisting of a BLUETOOTH component, an RFID component, an NFC component, a WIFI component, a geolocation system component, an electromagnetic sensor, an optical sensor, an RF indoor navigation and positioning system component, and a beacon signal receiver.

In a forty-third aspect, in addition to one or more of the preceding or following aspects, or in the alternative to some aspects, loss of balance events can be detected based on motion sensor signals crossing a threshold value of variance.

In a forty-fourth aspect, in addition to one or more of the preceding or following aspects, or in the alternative to some aspects, the ear-wearable device can further include a microphone.

In a forty-fifth aspect, in addition to one or more of the preceding or following aspects, or in the alternative to some aspects, loss of balance events can be detected based on at least one of the microphone signals and the motion sensor signals.

In a forty-sixth aspect, in addition to one or more of the preceding or following aspects, or in the alternative to some aspects, the ear-wearable device system can be configured to calculate balance recovery metrics after detected loss of balance events.

In a forty-seventh aspect, in addition to one or more of the preceding or following aspects, or in the alternative to some aspects, the balance recovery metrics can include a balance recovery time.

In a forty-eighth aspect, in addition to one or more of the preceding or following aspects, or in the alternative to some aspects, detected loss of balance events can be unprompted.

In a forty-ninth aspect, in addition to one or more of the preceding or following aspects, or in the alternative to some aspects, detected loss of balance events can be in response to a prompt or challenge.

In a fiftieth aspect, in addition to one or more of the preceding or following aspects, or in the alternative to some aspects, the ear-wearable device system can be configured to correlate medication administration times with detected loss of balance events.

In a fifty-first aspect, in addition to one or more of the preceding or following aspects, or in the alternative to some aspects, the ear-wearable device system can be configured to correlate time of day with detected loss of balance events.

In a fifty-second aspect, in addition to one or more of the preceding or following aspects, or in the alternative to some aspects, the ear-wearable device system can be configured to correlate occurrences of a daily event with detected loss of balance events.

In a fifty-third aspect, in addition to one or more of the preceding or following aspects, or in the alternative to some aspects, the daily event can include at least one selected from the group consisting of a bed time, a rising time, a meal time, and a bathroom time.

In a fifty-fourth aspect, in addition to one or more of the preceding or following aspects, or in the alternative to some aspects, the ear-wearable device system can be configured to detect vertical movement and correlate the same with detected loss of balance events.

In a fifty-fifth aspect, in addition to one or more of the preceding or following aspects, or in the alternative to some aspects, the vertical movement can include climbing stairs.

In a fifty-sixth aspect, in addition to one or more of the preceding or following aspects, or in the alternative to some aspects, the vertical movement can include rising from a chair.

In a fifty-seventh aspect, in addition to one or more of the preceding or following aspects, or in the alternative to some aspects, the ear-wearable device system can be configured to calculate a trend in detected loss of balance events over time.

In a fifty-eighth aspect, in addition to one or more of the preceding or following aspects, or in the alternative to some aspects, the ear-wearable device system can be configured to classify the severity of the detected loss of balance events.

In a fifty-ninth aspect, in addition to one or more of the preceding or following aspects, or in the alternative to some aspects, the ear-wearable device system can be configured to calculate a trend in the severity of loss of balance events over time.

In a sixtieth aspect, in addition to one or more of the preceding or following aspects, or in the alternative to some aspects, the ear-wearable device can be a hearing assistance device.

In a sixty-first aspect, in addition to one or more of the preceding or following aspects, or in the alternative to some aspects, the ear-wearable device system can be configured to detect loss of balance events within a home environment.

In a sixty-second aspect, in addition to one or more of the preceding or following aspects, or in the alternative to some aspects, the ear-wearable device system can be configured to detect loss of balance events within a work environment.

In a sixty-third aspect, in addition to one or more of the preceding or following aspects, or in the alternative to some aspects, the ear-wearable device system can be configured to detect loss of balance events within an out-of-home activity environment.

In a sixty-fourth aspect, in addition to one or more of the preceding or following aspects, or in the alternative to some aspects, the ear-wearable device can further include a clock circuit.

In a sixty-fifth aspect, in addition to one or more of the preceding or following aspects, or in the alternative to some aspects, the ear-wearable device system can further include a second ear-wearable device. The second ear-wearable device can include a second control circuit, a second motion sensor, and a second wireless signal receiver. The ear-wearable device system can be configured to detect loss of balance events using signals from both the ear-wearable device and the second ear-wearable device.

In a sixty-sixth aspect, a method of monitoring fall risk with a wearable device can be included, the method including detecting loss of balance events with the wearable device and determining physical location correlated with detected loss of balance events and logging the same.

In a sixty-seventh aspect, in addition to one or more of the preceding or following aspects, or in the alternative to some aspects, the method can further include providing a notification of physical locations associated with loss of balance events.

In a sixty-eighth aspect, in addition to one or more of the preceding or following aspects, or in the alternative to some aspects, the method can further include classifying the determined physical location as being a perpetual or transient danger.

In a sixty-ninth aspect, in addition to one or more of the preceding or following aspects, or in the alternative to some aspects, the method can further include providing a notification of physical locations associated with loss of balance events to a third party.

In a seventieth aspect, in addition to one or more of the preceding or following aspects, or in the alternative to some aspects, the method can further include providing suggestions to a caregiver regarding physical locations creating fall risk danger.

In a seventy-first aspect, in addition to one or more of the preceding or following aspects, or in the alternative to some aspects, the method can further include calculating balance recovery metrics after detected loss of balance events.

In a seventy-second aspect, in addition to one or more of the preceding or following aspects, or in the alternative to some aspects, the method can further include correlating medication administration times with detected loss of balance events.

In a seventy-third aspect, in addition to one or more of the preceding or following aspects, or in the alternative to some aspects, the method can further include correlating time of day with detected loss of balance events.

In a seventy-fourth aspect, in addition to one or more of the preceding or following aspects, or in the alternative to some aspects, the method can further include correlating occurrences of a daily event with detected loss of balance events.

In a seventy-fifth aspect, in addition to one or more of the preceding or following aspects, or in the alternative to some aspects, the method can further include detecting vertical movement and correlating the same with detected loss of balance events.

In a seventy-sixth aspect, in addition to one or more of the preceding or following aspects, or in the alternative to some aspects, the method can further include calculating a trend in detected loss of balance events over time.

In a seventy-seventh aspect, in addition to one or more of the preceding or following aspects, or in the alternative to some aspects, the method can further include classifying the severity of the detected loss of balance events.

In a seventy-eighth aspect, in addition to one or more of the preceding or following aspects, or in the alternative to some aspects, the method can further include calculating a trend in the severity of loss of balance events over time.

In a seventy-ninth aspect, in addition to one or more of the preceding or following aspects, or in the alternative to some aspects, the method can further include detecting loss of balance events within a home environment.

In an eightieth aspect, in addition to one or more of the preceding or following aspects, or in the alternative to some aspects, the method can further include detecting loss of balance events within a work environment.

In an eighty-first aspect, in addition to one or more of the preceding or following aspects, or in the alternative to some aspects, the method can further include detecting loss of balance events within an out-of-home activity environment.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic view of a device wearer and an ear-wearable device in accordance with various embodiments herein.

FIG. 2 is a plan view of a room in accordance with various embodiments herein.

FIG. 3 is a schematic view of an ear-wearable device in accordance with various embodiments herein.

FIG. 4 is a schematic view of an ear-wearable device disposed within the ear of a device wearer in accordance with various embodiments herein.

FIG. 5 is a schematic view of a device wearer and an ear-wearable device in accordance with various embodiments herein.

FIG. 6 is a schematic view of a device wearer experiencing a fall while wearing an ear-wearable device in accordance with various embodiments herein.

FIG. 7 is a plan view of a building in accordance with various embodiments herein.

FIG. 8 is a schematic view of components of a system in accordance with various embodiments herein.

FIG. 9 is a flowchart of operations of a method in accordance with various embodiments herein.

FIG. 10 is a schematic view of some components of an ear-wearable device system in accordance with various embodiments herein.

FIG. 11 is a schematic view of an accessory device in accordance with various embodiments herein.

FIG. 12 is a schematic view of data and/or signal flow as part of a system in accordance with various embodiments herein.

FIG. 13 is a schematic block diagram of components of an ear-wearable device in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, falls may occur because of a sudden loss of postural equilibrium occurring during normal daily activities such as rising from a chair or climbing or descending stairs. Falls may also occur because of external factors such as tripping over something or slipping on something.

Once fall risks for an individual are identified, various risk mitigation actions can be taken to reduce the chance of a fall occurring. However, complicating this, different locations can result in substantially different fall risks. This is because of what is in an individual's environment at a particular location (e.g., a rug at the base of a set of stairs that is not adequately secured to the floor) and/or because of activities that normally take place at a particular location (e.g., showering in the bathroom). This makes proper risk mitigation location specific. In addition, various environmental fall risks may be transitory or semi-transitory such as water spilled in the kitchen or a box which is temporarily placed in a walking path of a hallway. Further, because an individual's personal health condition impacts fall risk, proper risk mitigation is also individual specific. For these reasons, manually programming in or configuring all fall risk locations within an individual's environment to enable proper fall mitigation is generally untenable.

Embodiments herein include personal safety monitoring systems, such as those including ear-wearable devices or other wearable devices, that can be configured to detect loss of balance events, determine physical location correlated with detected loss of balance events, and then log the same. In this manner, locations with significant fall risk can be identified dynamically thereby reducing or eliminating the need for manual programming and/or configuration of fall risk at specific locations. Various other actions can be taken with this information including, but not limited to, providing notifications of physical locations associated with loss of balance events, providing a notification of physical locations associated with loss of balance events to a third party, classifying the determined physical location as being a perpetual or transient danger, providing suggestions to a caregiver regarding physical locations creating fall risk danger, calculating balance recovery metrics after detected loss of balance events, correlating medication administration times with detected loss of balance events, correlating time of day with detected loss of balance events, correlating occurrences of a daily event with detected loss of balance events, detecting vertical movement and correlating the same with detected loss of balance events, calculating a trend in detected loss of balance events over time, classifying the severity of the detected loss of balance events, and calculating a trend in the severity of loss of balance events over time.

In many cases, the loss of balance events that are detected and used to identify locations of significant fall risk are unprompted. In other words, the device simply monitors data until a loss of balance of event occurs. However, in some cases, a prompt or challenge can be given to the device wearer to generate a loss of balance event so as to record motion sensor or other data patterns associated with loss of balance events for a particular device wearer.

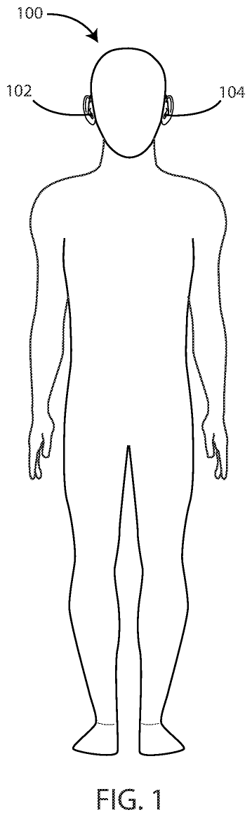

As one example, a personal safety monitoring system herein can include an ear-wearable device including a motion sensor and a wireless signal receiver. The wireless signal receiver can be, for example, a BLUETOOTH component, an RFID component, an NFC component, a WIFI component, a geolocation system component, an electromagnetic sensor, an optical sensor, an RF indoor navigation and positioning system component, and a beacon signal receiver. Referring now to FIG. 1, a schematic view is shown of a device wearer 100 with a personal safety monitoring system including ear-wearable devices 102 and 104. It will be appreciated, however, that in some cases a device wearer 100 may only have a single ear-wearable device. The ear-wearable devices 102, 104 can each include various components such as a control circuit, a motion sensor (and/or other sensor described herein), and a wireless signal receiver. The ear-wearable devices 102 and 104 can detect various indications of a loss of balance or a balance challenge event using data from the motion sensor and/or other sensors of a sensor package, from another device, or from another system. For example, the ear-wearable devices 102, 104 can be configured to analyze data from the sensor package and/or the microphone to detect that a loss of balance and/or a balance challenge event has occurred. Techniques of determining that a loss of balance and/or a balance challenge event has occurred are described in greater detail below but can include detecting patterns of motion sensor data and/or other data that matches a loss of balance and/or a balance challenge event. After detecting that a loss of balance and/or a balance challenge event has occurred the system can determine the physical location correlated with detected loss of balance events (e.g., what physical location was the device wearer at when the that a loss of balance and/or a balance challenge event occurred). This information and be logged and/or stored and then applied in various ways to mitigate fall risk in a location specific manner.

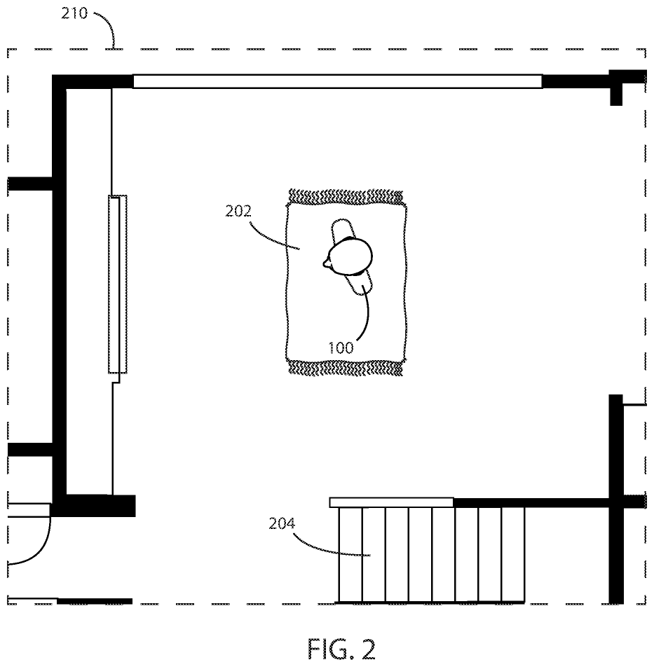

Various environmental fall risks may be present either transitorily, semi-transitory, or chronically in a given physical environment. Systems herein can account for such risks without being provided information about the same through manual programming or configuration. Referring now to FIG. 2, a plan view of a room 210 is shown in accordance with various embodiments herein. A device wearer 100 is in the room 210. The room 210 includes various elements that might be associated with a significant or above baseline value of fall risk. In this example, a rug 202 and stairs 204 are shown in the room 210. While not shown in this view, the device wearer 100 can be wearing an ear-wearable device as part of a personal safety monitoring system. The location of the rug 202 may represent an elevated fall risk location if the rug 202 slides along the floor too easily and/or if the rug 202 is tall enough to trip over. Similarly, the stairs 204 may represent an elevated fall risk if the device wearer 100 has weak muscles, is dizzy, or if another personal health condition is present. By detecting loss of balance events and/or balance challenge events and the physical locations associated with the same, systems herein can dynamically identify physical locations with significant fall risk in an environment (an occupiable structure, at home, out of home, at work, an outdoors site, etc.).

In some embodiments, a map of an occupiable structure such as a building can be generated automatically by the ear-wearable device and/or system. For example, as the ear-wearable device is moved (as the wearer moves) throughout the occupiable structure, records relating particular physical locations visited can be stored to progressively build the map of the structure. This map can then be utilized by the ear-wearable device or system for various purposes including, for example, describing the location of risk physical locations to a third party for risk mitigation purposes.

In various embodiments, the ear-wearable device is configured to calculate a present location of the ear-wearable device wearer 100. This can be performed in various ways. In some embodiments, the ear-wearable device 102 or another device in communication with the ear-wearable device 102 can include a spatial locator circuit. The spatial locator circuit can interface with various devices/systems in order to determine current spatial location via coordinates, referential signal, referential device, or the like. By way of example, the spatial locators circuit can interface with one or more of a device-to-device location service, a BLUETOOTH® beacon, a cell tower (or triangulation with multiple cell towers), a WIFI® router, a satellite (GPS L1/L2, GLONASS G1/G2, BeiDou B1/B2, Galileo E1/E5b, SBAS, or the like), or a telecoil loop cable, amongst other devices/systems. It will be appreciated that these specific examples are not exclusive and that various other techniques of determining location are also contemplated herein. In some embodiments, the spatial location determining device may determine location to a level of accuracy of 10 meters, 5 meters, 1 meter, 50 centimeters, 10 centimeters, 5 centimeters, or less, or a distance falling within a range between any of the foregoing.

In various embodiments, the spatial locator circuit can include a satellite signal receiver circuit. In various embodiments, the spatial locator circuit can include a device-to-device locator circuit. In various embodiments, the spatial locator circuit can include an electromagnetic sensor to detect the presence of a telecoil loop cable.

In various embodiments, the ear-wearable device is configured to calculate a present location of a wearer of the ear-wearable device by using properties of wireless transmissions received including at least one selected from the group consisting of angle of arrival, angle of departure, cell identity, time of arrival, time difference of arrival, and Rx power level. Angle of arrival and angle of departure can be used to determine a direction as well as a distance. Angle of arrival (AoA) and angle of departure (AoD) make use of the angular phase-shifts that occur between antennas as they receive (AoA) or transmit (AoD) RF signals. Time of arrival (ToA) is the travel time of a radio signal from a single transmitter to a remote single receiver, and its measurement is facilitated if both the transmitter and the receiver have (or receive signals from) the same clock or synchronized clocks. As such, time of arrival increases with increasing distance and therefore can be used to determined distance. Time difference of arrival at two points can be used to determine both distance and direction. Rx power level (or received signal strength indicator-RSSI) decreases with increasing distance. As such, evaluation of Rx power level can be used to determine distance. Measures of direction and distance can be combined in order to determine present location referentially.

In some embodiments, a present location can be determined based on e911 smartphone location information that can be passed from a smartphone (such as one belonging to the ear-wearable device wearer) to the ear-wearable device.

In some embodiments, a present location can be determined through dead reckoning off the double-integration of an acceleration sensor signal (or IMU signal) providing distance moved and direction once an accurate location has been determined. In some embodiments, dead reckoning can be performed relative to a calibrated beacon or other device with a known location, which could be a TV, smoke alarm, stove, or the like.

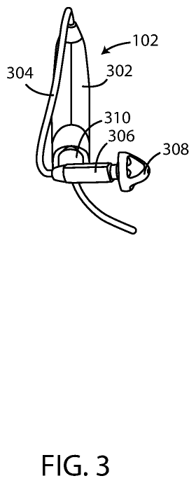

Personal safety monitoring systems herein can include ear-wearable devices or other wearable devices. Referring now to FIG. 3, a schematic view of an ear-wearable device 102 is shown in accordance with various embodiments herein. The ear-wearable device 102 can include a hearing device housing 302. The hearing device housing 302 can define a battery compartment 310 into which a battery can be disposed to provide power to the device. The ear-wearable device 102 can also include a receiver 306 adjacent to an earbud 308. The receiver 306 an include a component that converts electrical impulses into sound, such as an electroacoustic transducer, speaker, or loudspeaker. Such components can be used to generate an audible stimulus in various embodiments herein. A cable 304 or connecting wire can include one or more electrical conductors and provide electrical communication between components inside of the hearing device housing 302 and components inside of the receiver 306.

The ear-wearable device 102 shown in FIG. 3 is a receiver-in-canal type device and thus the receiver is designed to be placed within the ear canal. However, it will be appreciated that many different form factors for ear-wearable devices are contemplated herein. As such, ear-wearable devices herein can include, but are not limited to, behind-the-ear (BTE), in-the ear (ITE), in-the-canal (ITC), invisible-in-canal (IIC), receiver-in-canal (RIC), receiver in-the-ear (RITE) and completely-in-the-canal (CIC) type hearing assistance devices.

The term “ear-wearable device” shall also refer to devices that can produce optimized or processed sound for persons with normal hearing. Ear-wearable devices herein can include hearing assistance devices. In some embodiments, the ear-wearable device can be a hearing aid falling under 21 C.F.R. § 801.420. In another example, the ear-wearable device can include one or more Personal Sound Amplification Products (PSAPs). In another example, the ear-wearable device can include one or more cochlear implants, cochlear implant magnets, cochlear implant transducers, and cochlear implant processors. In another example, the ear-wearable device can include one or more “hearable” devices that provide various types of functionality. In other examples, ear-wearable devices can include other types of devices that are wearable in, on, or in the vicinity of the user's ears. In other examples, ear-wearable devices can include other types of devices that are implanted or otherwise osseointegrated with the user's skull; wherein the device is able to facilitate stimulation of the wearer's ears via the bone conduction pathway.

Ear-wearable devices of the present disclosure can incorporate an antenna arrangement coupled to a radio, such as a 2.4 GHz radio. The radio can conform to an IEEE 802.11 (e.g., WIFI®) or BLUETOOTH® (e.g., BLE, BLUETOOTH® 4. 2 or 5.0) specification, for example. It is understood that ear-wearable devices of the present disclosure can employ other radios, such as a 900 MHz radio. Ear-wearable device of the present disclosure can also include hardware, such as one or more antennas, for NFMI or NFC wireless communications. Ear-wearable devices of the present disclosure can be configured to receive streaming audio (e.g., digital audio data or files) from an electronic or digital source. Representative electronic/digital sources (also referred to herein as accessory devices) include an assistive listening system, a TV streamer, a radio, a smartphone, a cell phone/entertainment device (CPED) or other electronic device that serves as a source of digital audio data or files.

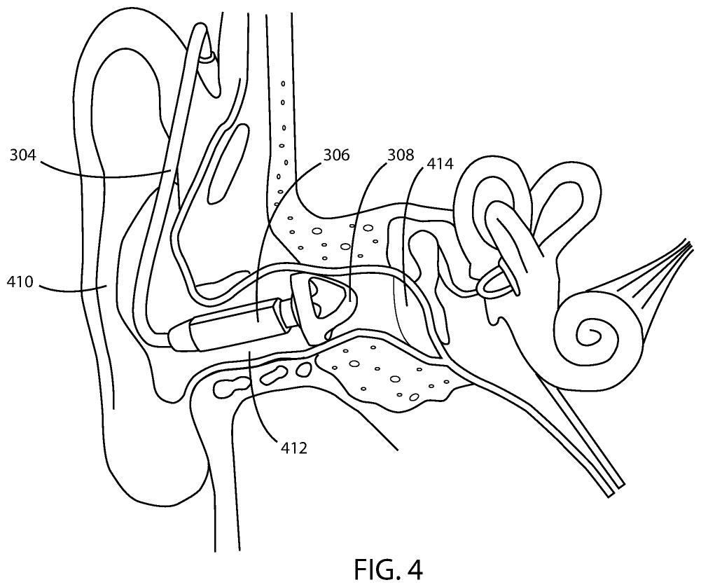

As mentioned above, the ear-wearable device 102 shown in FIG. 3 can be a receiver-in-canal type device and thus the receiver is designed to be placed within the ear canal. Referring now to FIG. 4, a schematic view is shown of an ear-wearable device 102 disposed within the ear of a device wearer in accordance with various embodiments herein. In this view, the receiver 306 and the earbud 308 are both within the ear canal 412, but do not directly contact the tympanic membrane 414. The hearing device housing is mostly obscured in this view behind the pinna 410, but it can be seen that the cable 304 passes over the top of the pinna 410 and down to the entrance to the ear canal 412.

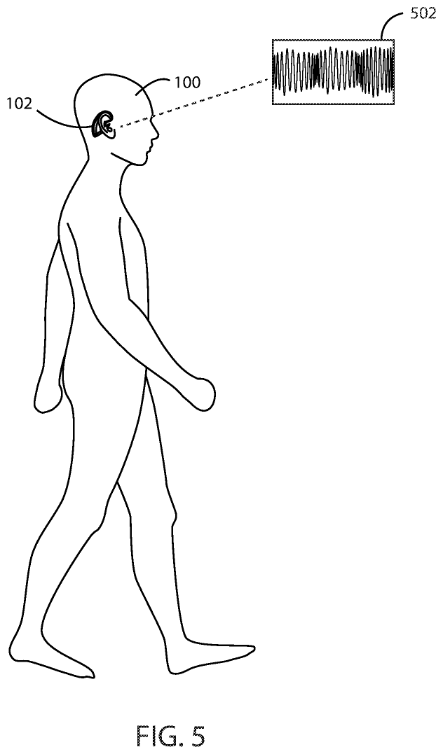

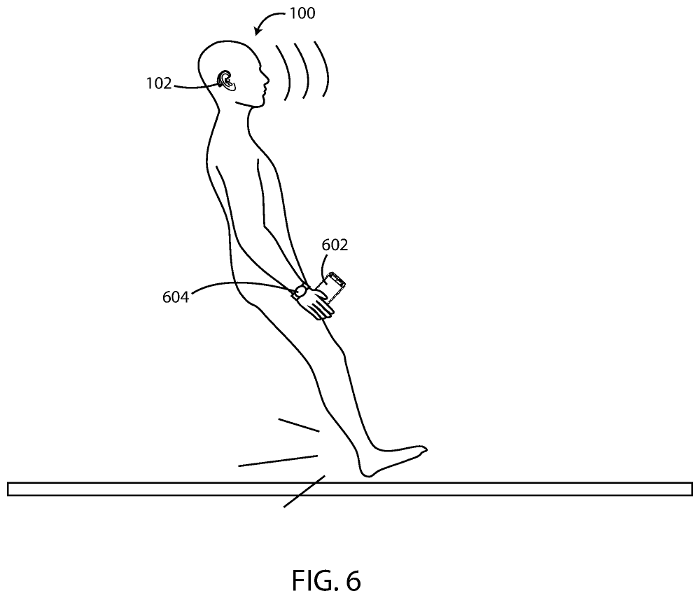

Referring now to FIG. 5, a schematic view of a device wearer 100 with an ear-wearable device 102 is shown in accordance with various embodiments herein. In various embodiments, the ear-wearable device 102 can include a motion sensor, wherein the ear-wearable device 102 can be configured to detect loss of balance events of the device wearer 100 using signals 502 from the motion sensor (motion data) and/or other types of data described herein. Referring now to FIG. 6, a schematic view is shown of a device wearer 100 experiencing a loss of balance event. In this view, the device wearer 100 is wearing an ear-wearable device 102 that is (as worn) in a fixed position relative to their head. In this case, the device wearer 100 also has a first accessory device 602. In this example, the device wearer also has a second accessory device 604. Such accessory devices can be part of personal safety monitoring systems herein. Accessory devices herein can include, but are not limited to, a smart phone, cellular telephone, personal digital assistant, personal computer, streaming device, wide area network device, personal area network device, remote microphone, smart watch, home monitoring device, internet gateway, hearing aid accessory, TV streamer, wireless audio streaming device, landline streamer, remote control, Direct Audio Input (DAI) gateway, audio gateway, telecoil receiver, hearing device programmer, charger, drying box, smart glasses, a captioning device, a wearable or implantable health monitor, and combinations thereof, or the like. Hardware components consistent with various accessory devices are described in U.S. Publ. Appl. No. 2018/0341582, the content of which is herein incorporated by reference.

Loss of balance events can create distinctive signal/data patterns that when identified can be taken as an occurrence of a loss of balance event. By way of example, movement of the device wearer can include greater than normal lateral head movement, head movement oscillations, head tipping, and postural changes as they experience a loss of balance event and then try to recover their balance. In some embodiments, loss of balance events are detected based on motion sensor signals crossing a threshold value of variance. In some embodiments, systems and/or devices herein can store one or more templates associated with loss of balance events (positive and/or negative examples). The system and/or device can undertake a pattern matching operation (describe in greater detail below) to determine which template represents the best match for the movement data and/or other data. If a match is found for a template associated with a loss of balance event, then the system can treat that set of movement data and/or other data a representing the occurrence of a loss of balance event. Microphone data can also be used herein to detect utterances, exclamations, or other sound associated with a loss of balance event, such as “whoa” or a scream occurring in conjunction with movement consistent with a loss of balance. As such, in various embodiments, detection of loss of balance events can be based on at least one of microphone signals and motion sensor signals

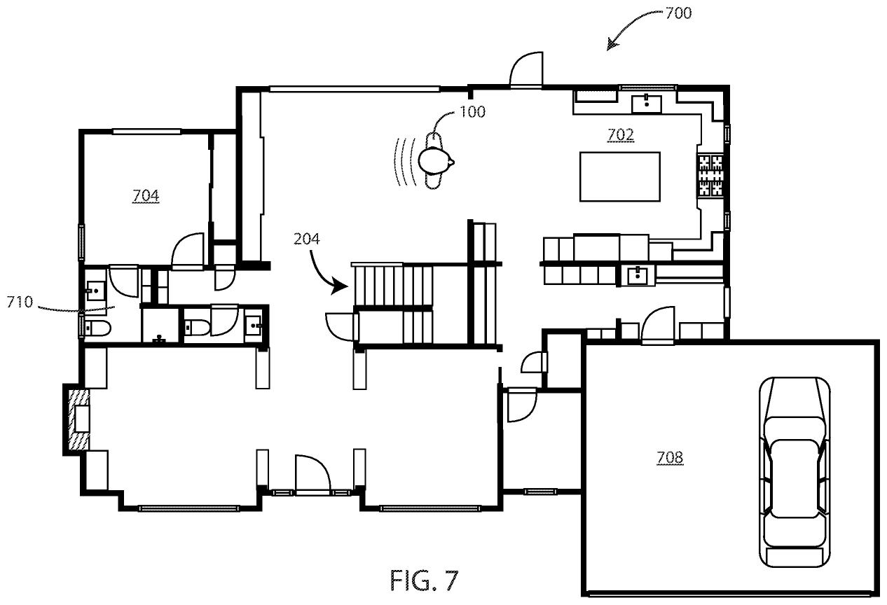

In various embodiments, the system and/or device herein can identify various rooms or areas of an occupiable structure that include locations of significant fall risk. Referring now to FIG. 7, a plan view of a building 700 is shown in accordance with various embodiments herein. In this example, the building 700 can include various rooms including a kitchen 702, a bedroom 704, stairs 204, a garage 708, a bathroom 710. FIG. 7 also shows a device wearer 100 within the building 700. In some embodiments, specific rooms can be identified based on wireless signal transmitting beacons within the same. In some embodiments, specific rooms can be identified based on the combination of wireless signals detectable within the room. In various embodiments herein, the system and/or device herein can identify that the device wearer 100 has experienced a loss of balance within a specific room or area of the building 700 such as within the kitchen 702, bedroom 704, garage 708, bathroom 710, or on the stairs 204. Such information can be provided in reports and/or in transmission to third parties herein. In some embodiments, the location data herein can include an indication of the floor of a building that the location is on.

Some physical locations may represent a perpetual danger for a given individual, such as stairs 204. However, some physical locations, such as a kitchen 702 may only represent a transient danger, such as when a liquid has spilled on the floor of the kitchen 702. In various embodiments, personal safety monitoring systems herein can be configured to classify a determined physical location as being a perpetual or transient danger. By way of example, if loss of balance events happen consistently over time at a particular location, then that location can be deemed to represent a perpetual danger. However, if loss of balance events only happened during a particular limited time period at a particular location, then that location can be deemed to represent a transient danger.

Various other events or circumstances may be associated with loss of balance events. For example, medications may impact loss of balance events. In some embodiments, systems or devices herein can be configured to correlate medication administration times (as detected or provided as data from an individual or another system) with detected loss of balance events. The time of day may also be associated with loss of balance events. For example, the morning may represent a time of higher fall risk. In some embodiments, a clock circuit can be included with systems and/or devices herein and the system or device can be configured to correlate time of day with detected loss of balance events. Similarly, in some embodiments, the system or device is configured to correlate occurrences of a daily event with detected loss of balance events. In some embodiments, the daily event comprising at least one selected from the group consisting of a bed time, a rising time, a meal time, and a bathroom time. In some embodiments, the system or device is configured to detect vertical movement and correlate the same with detected loss of balance events. In some cases, the vertical movement can include climbing stairs. In some cases, the vertical movement comprising rising from a chair.

In various embodiments, systems or devices herein can be configured to calculate balance recovery metrics after detected loss of balance events. For example, balance recovery metrics can include a balance recovery time (e.g., how long did it take for movement data or other data to return to normal or baseline values).

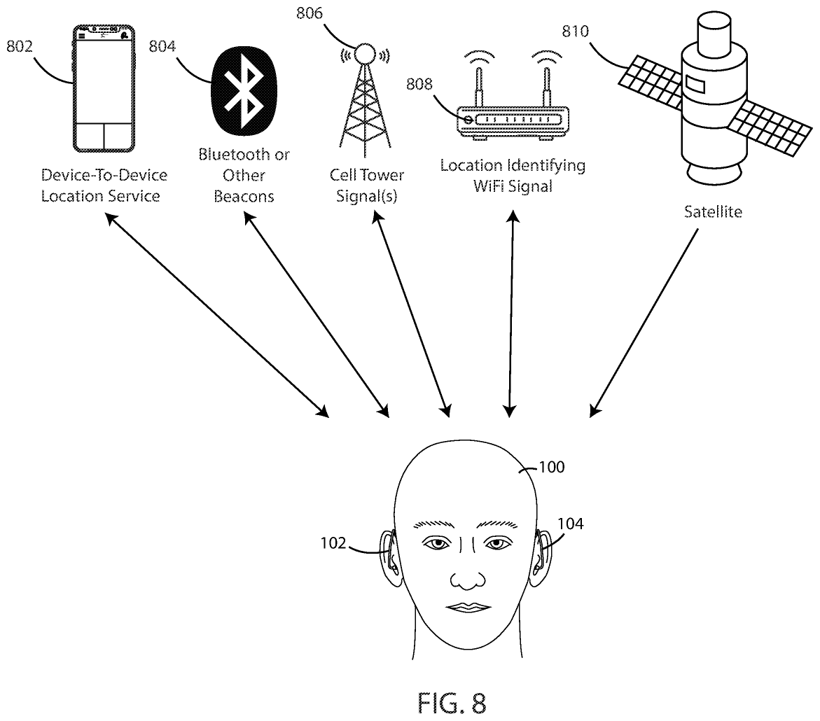

It will be appreciated that in some embodiments an ear-wearable device 102 can include a spatial locator circuit and therefore directly determine spatial location. Referring now to FIG. 8, a schematic view of some components of a personal safety monitoring system is shown in accordance with various embodiments herein. In this view, a device wearer 100 is shown with a first ear-wearable device 102 and a second ear-wearable device 104 (however, various hearing assistance systems herein may only include a single ear-wearable device).

In this embodiment, at least one of the first ear-wearable device 102 and the second ear-wearable device 104 can directly interface with one or more of a device-to-device location service 802, a BLUETOOTH® beacon 804, a cell tower 806, a WIFI® router 808, a satellite 810, or a telecoil loop cable, amongst other devices/systems. In various embodiments herein, the spatial location circuit can be integrated within a housing with the first ear-wearable device 102 and/or the second ear-wearable device 104.

Many different methods are contemplated herein, including, but not limited to, methods of making, methods of using, and the like. Aspects of system/device operation described elsewhere herein can be performed as operations of one or more methods in accordance with various embodiments herein.

Aspects of system/device operation described elsewhere herein can be performed as operations of one or more methods in accordance with various embodiments herein. In various embodiments, operations described herein and method steps can be performed as part of a computer-implemented method executed by one or more processors of one or more computing devices. In various embodiments, operations described herein and method steps can be implemented instructions stored on a non-transitory, computer-readable medium that, when executed by one or more processors, cause a system to execute the operations and/or steps.

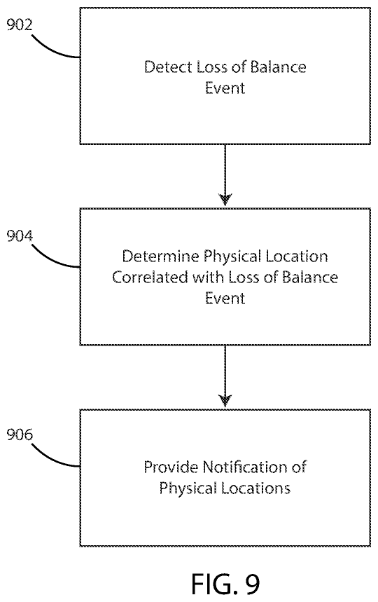

In an embodiment, a method of monitoring fall risk with a wearable device is included. Referring now to FIG. 9, a flow chart of operations of a method herein is described. The method can include an operation of detecting loss of balance events with the wearable device 902. The method can further include an operation of determining physical location correlated with detected loss of balance events 904 and in some cases logging the same. The method can also include an operation of providing a notification of physical locations associated with loss of balance events 906.

Various other operations can be performed. In an embodiment, the method can further include classifying the determined physical location as being a perpetual or transient danger.

In an embodiment, the method can further include providing a notification of physical locations associated with loss of balance events to a third party.

In an embodiment, the method can further include providing suggestions to a caregiver regarding physical locations creating fall risk danger.

In an embodiment, the method can further include calculating balance recovery metrics after detected loss of balance events.

In an embodiment, the method can further include correlating medication administration times with detected loss of balance events. In an embodiment, the method can further include correlating time of day with detected loss of balance events. In an embodiment, the method can further include correlating occurrences of a daily event with detected loss of balance events.

In an embodiment, the method can further include detecting vertical movement and correlating the same with detected loss of balance events.

In an embodiment, the method can further include calculating a trend in detected loss of balance events over time.

In an embodiment, the method can further include classifying the severity of the detected loss of balance events. In an embodiment, the method can further include calculating a trend in the severity of loss of balance events over time.

In an embodiment, the method can further include detecting loss of balance events within a home environment. In an embodiment, the method can further include detecting loss of balance events within a work environment. In an embodiment, the method can further include detecting loss of balance events within an out-of-home activity environment.

In some embodiments, an ear-wearable device herein can be part of a system that may also include other components/devices. By way of example, in some embodiments, a system herein can also include an accessory device. The accessory device can communicate with the ear-wearable device(s) and exchange general data, sensor data, notifications, convey messages or commands, etc. In some embodiments, processing intensive tasks can be offloaded to the accessory device. In some embodiments, data used to detect loss of balance events can be received from the accessory device. In some embodiments, data operations such as pattern matching operations herein can be performed on the accessory device.

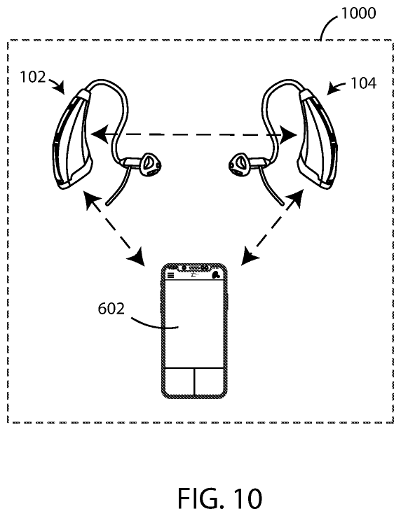

Referring now to FIG. 10, a schematic view of some components of an ear-wearable device system 1000 is shown in accordance with various embodiments herein. FIG. 10 shows an ear-wearable device 102 and a second ear-wearable device 104. FIG. 10 also shows an accessory device 602.

In various embodiments, signals and/or data can be exchanged between the ear-wearable device 102 and the second ear-wearable device 104. As one example, a loss of balance event can be determined using both the first ear-wearable device 102 and a second ear-wearable device 104 worn by the wearer. In some embodiments, an indication of a loss of balance event as identified by the second ear-wearable device 104 can be transmitted to the first ear-wearable device 102. Then the ear-wearable device 102 can compare the information that is received against what it calculates itself and if the outcome is in agreement (e.g., a loss of balance event has occurred, or no loss of balance event has occurred) then the ear-wearable device 102 can be assured that the detection of a loss of balance event is accurate.

In various embodiments, the location of the wearer can be determined based on a geolocation of the accessory device 602 that can be transmitted to the ear-wearable device(s). For example, in some embodiments, the accessory device 602 may include a locating circuit (or geolocation circuit) which can be used to determine the geolocation of the accessory device 602 and this location can be transmitted on to the ear-wearable device(s).

In some embodiments, the accessory device 602 can be used to convey a control command on to a controllable device. For example, in some embodiments, the first ear-wearable device 102 can transmit a control command to the accessory device 602 (such as via BLUETOOTH) and the accessory device 602 can then transmit the control command onto one or more controllable devices via WIFI or another wired or wireless protocol. It will be appreciated that various security measures can also be used with ear-wearable devices and/or systems herein including, but not limited to authentication, encryption, pairing protocols, and other known security techniques/measures.

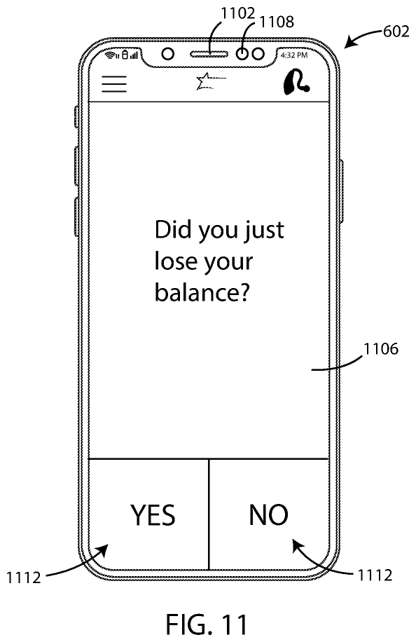

In various embodiments, devices herein can query the device wearer using an ear-wearable device and/or an accessory device. Referring now to FIG. 11, a schematic view of an accessory device 602 is shown in accordance with various embodiments herein. The accessory device 602 can include a display screen 1106 thereof. The accessory device 602 can also include a speaker 1102 and a front-facing camera 1108.

In various embodiments, the ear-wearable device can be configured to query the device wearer 100 regarding whether or not a loss of balance event has occurred. As previously stated, in some cases this can be done by directly by the ear-wearable device and in some cases this can be done utilizing the accessory device 602. For example, a query can be displayed using the display screen 1106 and the device wearer and provide input using one or more input elements 1112. Input from the device wearer received in this manner can be used to confirm whether or not a loss of balance event has actually occurred. Input from the device wearer received in this manner can also be used to further generate templates or machine learning models to more accurately characterize data as reflecting a loss of balance event or not.

In various embodiments, the ear-wearable device and/or the accessory device can be used to provide notifications and/or warnings such as audibly, visually, and/or haptically. For example, in some embodiments the personal safety monitoring system can be configured to provide a notification of physical locations associated with loss of balance events. In some embodiments, a notification herein can include a warning of danger and the notification can be delivered prior to encountering and/or reencountering the physical location. For example, present location can be determined using techniques described herein and if that location is adjacent a location associated with a significant fall risk (such as a location where previous loss of balance events have occurred), then a warning of danger can be provided. In some embodiments, the notification includes a warning of danger and the notification is delivered when a device wearer is approaching a physical location associated with a significant fall risk.

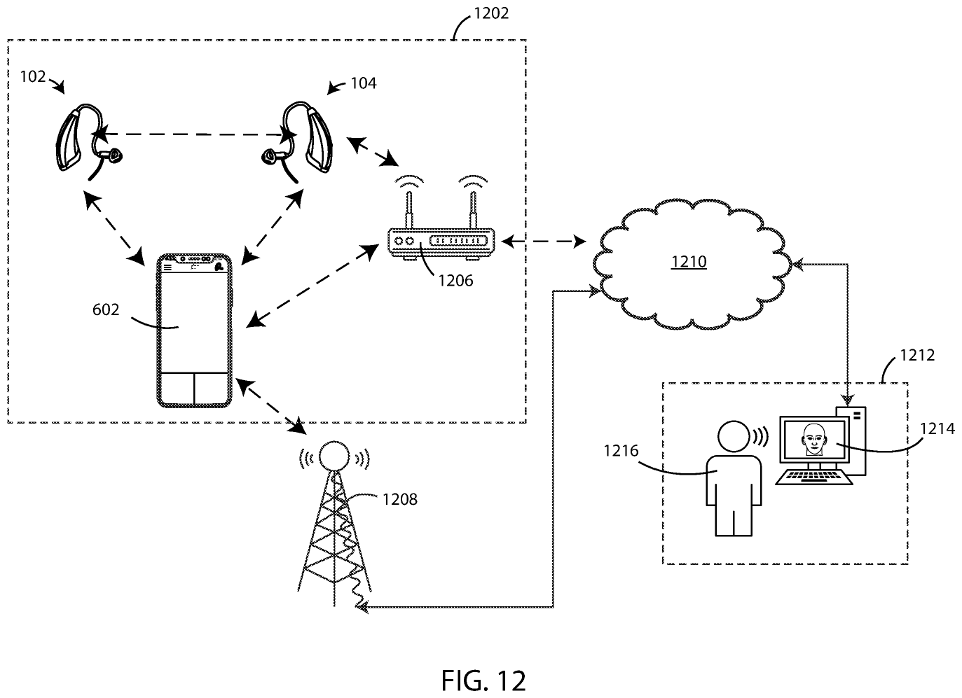

Referring now to FIG. 12, a schematic view is shown of data and/or signal flow as part of a system in accordance with various embodiments herein. At a first site 1202, a device wearer (not shown) can have a first ear-wearable device 102 and a second ear-wearable device 104. Each of the ear-wearable devices 102, 104 can include sensors as described herein including, for example, a motion sensor. The ear-wearable devices 102, 104 and sensors therein can be disposed on opposing lateral sides of the device wearer's head. In some embodiments, the ear-wearable devices 102, 104 and sensors therein can be disposed in a fixed position relative to the device wearer's head. The ear-wearable devices 102, 104 and sensors therein can be disposed within opposing ear canals of the device wearer. The ear-wearable devices 102, 104 and sensors therein can be disposed on or in opposing ears of the device wearer.

In various embodiments, data and/or signals can be exchanged directly between the first ear-wearable device 102 and the second ear-wearable device 104. An accessory device 602 with a video display screen, such as a smart phone, can also be disposed within the first site 1202. The accessory device 602 can exchange data and/or signals with one or both of the first ear-wearable device 102 and the second ear-wearable device 104 and/or with another accessory to the ear-wearable devices (e.g., a remote microphone, a remote control, a phone streamer, etc.). The accessory device 602 can also exchange data across a data network to the cloud 1210, such as through a wireless signal connecting with a local gateway device, such as a network router 1206, mesh network, or through a wireless signal connecting with a cell tower 1208 or similar communications tower. In some embodiments, the accessory device 602 can also connect to a data network to provide communication to the cloud 1210 through a direct wired connection. Various operations herein including, for example, pattern matching operations can be performed using computing resources in the cloud 1210 in some embodiments.

In some embodiments, a care provider 1216 (such as an audiologist, physical therapist, a physician or a different type of clinician, specialist, a care provider, a physical trainer) or other third party (such as a third-party device wearer) can receive information from devices at the first site 1202 remotely at a second site 1212 through a data communication network such as that represented by the cloud 1210. The care provider 1216 can use a computing device 1214 to see and interact with the information received. The received information can include, but is not limited to, information regarding the loss of balance events experienced by the device wearer and aspects regarding the same such as frequencies, trends, locations associated with the events, and the like. In some embodiments, received information can be provided to the care provider 1216 in real time. In some embodiments, received information can be stored and provided to the care provider 1216 at a later time point. In some embodiments, the personal safety monitoring system can be configured to provide a notification of physical locations associated with loss of balance events to the care provider 1216 or a third party. In some embodiments, the personal safety monitoring system is configured to provide suggestions to a caregiver regarding physical locations correlated with or otherwise creating fall risk danger. The suggestions can include risk mitigation suggestions such as moving an object, installing hand rails, traction mats, or the like.

In some embodiments, the care provider 1216 (such as an audiologist, physical therapist, a physician or a different type of clinician, specialist, or care provider, or physical trainer) can send information remotely from the second site 1212 through a data communication network such as that represented by the cloud 1210 to devices at the first site 1202. For example, the care provider 1216 can enter information into the computing device 1214, can use a camera connected to the computing device 1214 and/or can speak into the external computing device. The sent information can include, but is not limited to, feedback information, fall risk mitigation information, and the like. In some embodiments, feedback information from the care provider 1216 can be provided to the device wearer in real time.

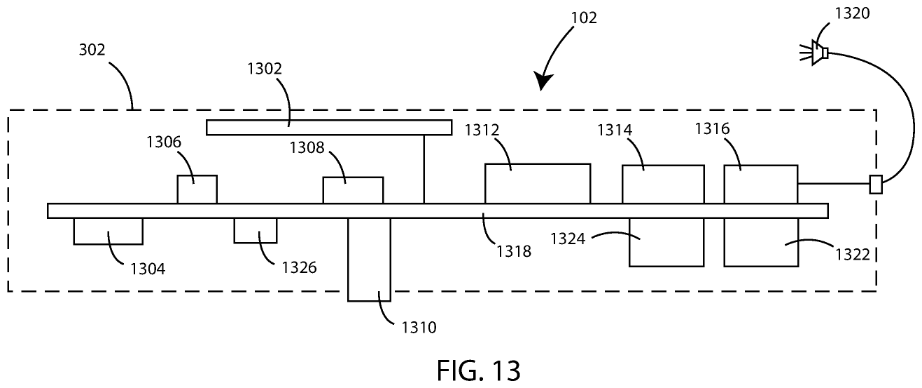

Referring now to FIG. 13, a schematic block diagram of components of an exemplary ear-wearable device is shown in accordance with various embodiments herein. The block diagram of FIG. 13 represents a generic ear-wearable device for purposes of illustration. The ear-wearable device 102 shown in FIG. 13 includes several components electrically connected to a flexible mother circuit 1318 (e.g., flexible mother board) which is disposed within housing 302. A power supply circuit 1304 can include a battery and can be electrically connected to the flexible mother circuit 1318 and provides power to the various components of the ear-wearable device 102. One or more microphones 1306 are electrically connected to the flexible mother circuit 1318, which provides electrical communication between the microphones 1306 and a digital signal processor (DSP) 1312. Among other components, the DSP 1312 incorporates or is coupled to audio signal processing circuitry configured to implement various functions described herein. A sensor package 1314 can be coupled to the DSP 1312 via the flexible mother circuit 1318. The sensor package 1314 can include one or more different specific types of sensors such as those described in greater detail below. One or more user switches 1310 (e.g., on/off, volume, mic directional settings) are electrically coupled to the DSP 1312 via the flexible mother circuit 1318.

An audio output device 1316 is electrically connected to the DSP 1312 via the flexible mother circuit 1318. In some embodiments, the audio output device 1316 comprises an electroacoustic transducer or speaker (coupled to an amplifier). In other embodiments, the audio output device 1316 comprises an amplifier coupled to an external receiver 1320 adapted for positioning within an ear of a wearer. The external receiver 1320 can include an electroacoustic transducer, speaker, or loudspeaker. The ear-wearable device 102 may incorporate a communication device 1308 coupled to the flexible mother circuit 1318 and to an antenna 1302 directly or indirectly via the flexible mother circuit 1318. The communication device 1308 can be a BLUETOOTH® transceiver, such as a BLE (BLUETOOTH® low energy) transceiver or other transceiver(s) (e.g., an IEEE 802.11 compliant device). The communication device 1308 can be configured to communicate with one or more external devices, such as those discussed previously, in accordance with various embodiments. In various embodiments, the communication device 1308 can be configured to communicate with an external visual display device such as a smart phone, a video display screen, a tablet, a computer, or the like.

In various embodiments, the ear-wearable device 102 can also include a control circuit 1322 and a memory storage device 1324. The control circuit 1322 can be in electrical communication with other components of the device. In some embodiments, a clock circuit 1326 can be in electrical communication with the control circuit. The control circuit 1322 can execute various operations, such as those described herein. The control circuit 1322 can include various components including, but not limited to, a microprocessor, a microcontroller, an FPGA (field-programmable gate array) processing device, an ASIC (application specific integrated circuit), or the like. The memory storage device 1324 can include both volatile and non-volatile memory. The memory storage device 1324 can include ROM, RAM, flash memory, EEPROM, SSD devices, NAND chips, and the like. The memory storage device 1324 can be used to store data from sensors as described herein and/or processed data generated using data from sensors as described herein.

It will be appreciated that various of the components described in FIG. 13 can be associated with separate devices and/or accessory devices to the ear-wearable device. By way of example, microphones can be associated with separate devices and/or accessory devices. Similarly, audio output devices can be associated with separate devices and/or accessory devices to the ear-wearable device.

Loss of Balance Event Detection with Pattern Identification and Matching

It will be appreciated that in various embodiments herein, a device or a system can be used to detect a pattern or patterns (such as patterns of data from sensors) indicative of a loss of balance event. Such patterns can be detected in various ways. Some techniques are described elsewhere herein, but some further examples will now be described.

As merely one example, one or more sensors can be operatively connected to a controller (such as the control circuit described in FIG. 13) or another processing resource (such as a processor of another device or a processing resource in the cloud). The controller or other processing resource can be adapted to receive data representative of a characteristic of the subject from one or more of the sensors and/or determine statistics of the subject over a monitoring time period based upon the data received from the sensor. As used herein, the term “data” can include a single datum or a plurality of data values or statistics. The term “statistics” can include any appropriate mathematical calculation or metric relative to data interpretation, e.g., probability, confidence interval, distribution, range, or the like. Further, as used herein, the term “monitoring time period” means a period of time over which characteristics of the subject are measured and statistics are determined. The monitoring time period can be any suitable length of time, e.g., 10 seconds, 30 seconds, 1 minute, 10 minutes, 30 minutes, 1 hour, 1 day, 1 week, etc., or a range of time between any of the foregoing time periods.

Any suitable technique or techniques can be utilized to determine statistics for the various data from the sensors, e.g., direct statistical analyses of time series data from the sensors, differential statistics, comparisons to baseline or statistical models of similar data, etc. Such techniques can be general or individual-specific and represent long-term or short-term behavior. These techniques could include standard pattern classification methods such as Gaussian mixture models, clustering as well as Bayesian approaches, neural network models and deep learning, and the like.

Further, in some embodiments, the controller can be adapted to compare data, data features, and/or statistics against various other patterns or templates, which could be prerecorded patterns (baseline patterns) of the particular individual wearing an ear-wearable device herein, prerecorded patterns (group baseline patterns) of a group of individuals wearing ear-wearable devices herein, one or more predetermined patterns that serve as positive example patterns (such as patterns indicative of loss of balance events), negative example patterns, or the like. As merely one scenario, if a pattern is detected in an individual that exhibits similarity crossing a threshold value to a positive example pattern or substantial similarity to that pattern, then that can be taken as an indication of the occurrence of a loss of balance event associated with the positive example pattern. Positive and/or negative example patterns can be stored or accessed for use covering those items to be detected in accordance with embodiments herein including, but not limited to, loss of balance events and events impacting loss of balance. In some embodiments, patterns or templates can be indexed for severity of the loss of balance event. In this manner, the severity of a loss of balance event can be characterized. However, in some embodiments, severity can simply be characterized by the magnitude of motion sensor or other sensor signals. In some embodiments, a trend in severity over time can be calculated.

Similarity and dissimilarity can be measured directly via standard statistical metrics such normalized Z-score, or similar multidimensional distance measures (e.g. Mahalanobis or Bhattacharyya distance metrics), or through similarities of modeled data and machine learning. These techniques can include standard pattern classification methods such as Gaussian mixture models, clustering as well as Bayesian approaches, neural network models, and deep learning.

As used herein the term “substantially similar” means that, upon comparison, the sensor data are congruent or have statistics fitting the same statistical model, each with an acceptable degree of confidence. The threshold for the acceptability of a confidence statistic may vary depending upon the subject, sensor, sensor arrangement, type of data, context, condition, etc.

The statistics associated with the loss of balance event of an individual over the monitoring time period, can be determined by utilizing any suitable technique or techniques, e.g., standard pattern classification methods such as Gaussian mixture models, clustering, hidden Markov models, as well as Bayesian approaches, neural network models, and deep learning.

Various embodiments herein specifically include the application of a machine learning classification model. In various embodiments, the ear-wearable system can be configured to periodically update the machine learning classification model based on indicators of loss of balance events experienced by the device wearer.

In some embodiments, a training set of data can be used in order to generate a machine learning classification model. The input data can include motion sensor data and/or sensor data as described herein as tagged/labeled with binary and/or non-binary classifications of loss of balance. Binary classification approaches can utilize techniques including, but not limited to, logistic regression, k-nearest neighbors, decision trees, support vector machine approaches, naive Bayes techniques, and the like. Multi-class classification approaches (e.g., for non-binary classifications of triggers and/or allergic reactions) can include k-nearest neighbors, decision trees, naive Bayes approaches, random forest approaches, and gradient boosting approaches amongst others.

In various embodiments, the ear-wearable system is configured to execute operations to generate or update the machine learning model on the ear-wearable device itself. In some embodiments, the ear-wearable system may convey data to another device such as an accessory device or a cloud computing resource in order to execute operations to generate or update a machine learning model herein. In various embodiments, the ear-wearable system is configured to weight certain possible detected indicators of loss of balance events in the machine learning classification model more heavily based on derived correlations specific for the individual as described elsewhere herein.

### Sensors

Ear-wearable devices herein can include one or more sensor packages (including one or more discrete or integrated sensors) to provide data. The sensor package can comprise one or a multiplicity of sensors. In some embodiments, the sensor packages can include one or more motion sensors (or movement sensors) amongst other types of sensors. Motion sensors herein can include inertial measurement units (IMU), accelerometers, gyroscopes, barometers, altimeters, and the like. The IMU can be of a type disclosed in commonly owned U.S. Pat. No. 9,848,273, which is incorporated herein by reference. In some embodiments, electromagnetic communication radios or electromagnetic field sensors (e.g., telecoil, NFMI, TMR, GMR, etc.) sensors may be used to detect motion or changes in position. In various embodiments, the sensor package can include a magnetometer. In some embodiments, biometric sensors may be used to detect body motions or physical activity. Motions sensors can be used to track movement of a patient in accordance with various embodiments herein.

In some embodiments, the motion sensors can be disposed in a fixed position with respect to the head of a patient, such as worn on or near the head or ears. In some embodiments, the operatively connected motion sensors can be worn on or near another part of the body such as on a wrist, arm, or leg of the patient.

According to various embodiments, the sensor package can include one or more of an IMU, and accelerometer (3, 6, or 9 axis), a gyroscope, a barometer, an altimeter, a magnetometer, a magnetic sensor, an eye movement sensor, a pressure sensor, an acoustic sensor, a telecoil, a heart rate sensor, a global positioning system (GPS), a temperature sensor, a blood pressure sensor, an oxygen saturation sensor, an optical sensor, a blood glucose sensor (optical or otherwise), a galvanic skin response sensor, a cortisol level sensor (optical or otherwise), a microphone, acoustic sensor, an electrocardiogram (ECG) sensor, electroencephalography (EEG) sensor which can be a neurological sensor, eye movement sensor (e.g., electrooculogram (EOG) sensor), myographic potential electrode sensor (EMG), a heart rate monitor, a pulse oximeter or oxygen saturation sensor (SpO2), a wireless radio antenna, blood perfusion sensor, hydrometer, sweat sensor, cerumen sensor, air quality sensor, pupillometry sensor, cortisol level sensor, hematocrit sensor, light sensor, image sensor, and the like.

In some embodiments, the sensor package can be part of an ear-wearable device. However, in some embodiments, the sensor packages can include one or more additional sensors that are external to an ear-wearable device. For example, various of the sensors described above can be part of a wrist-worn or ankle-worn sensor package, or a sensor package supported by a chest strap. In some embodiments, sensors herein can be disposable sensors that are adhered to the device wearer (“adhesive sensors”) and that provide data to the ear-wearable device or another component of the system.

Data produced by the sensor(s) of the sensor package can be operated on by a processor of the device or system.

As used herein the term “inertial measurement unit” or “IMU” shall refer to an electronic device that can generate signals related to a body's specific force and/or angular rate. IMUs herein can include one or more accelerometers (3, 6, or 9 axis) to detect linear acceleration and a gyroscope to detect rotational rate. In some embodiments, an IMU can also include a magnetometer to detect a magnetic field.

The eye movement sensor may be, for example, an electrooculographic (EOG) sensor, such as an EOG sensor disclosed in commonly owned U.S. Pat. No. 9,167,356, which is incorporated herein by reference. The pressure sensor can be, for example, a MEMS-based pressure sensor, a piezo-resistive pressure sensor, a flexion sensor, a strain sensor, a diaphragm-type sensor and the like.

The temperature sensor can be, for example, a thermistor (thermally sensitive resistor), a resistance temperature detector, a thermocouple, a semiconductor-based sensor, an infrared sensor, or the like.

The blood pressure sensor can be, for example, a pressure sensor. The heart rate sensor can be, for example, an electrical signal sensor, an acoustic sensor, a pressure sensor, an infrared sensor, an optical sensor, or the like.

The oxygen saturation sensor (such as a blood oximetry sensor) can be, for example, an optical sensor, an infrared sensor, a visible light sensor, or the like.

The electrical signal sensor can include two or more electrodes and can include circuitry to sense and record electrical signals including sensed electrical potentials and the magnitude thereof (according to Ohm's law where V=IR) as well as measure impedance from an applied electrical potential.

It will be appreciated that the sensor package can also include one or more sensors that are external to the ear-wearable device. In addition to the external sensors discussed hereinabove, the sensor package can comprise a network of body sensors (such as those listed above) that sense movement of a multiplicity of body parts (e.g., arms, legs, torso).

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A personal safety monitoring system comprising:
a wearable device, the wearable device comprising
a control circuit;
a motion sensor; and
a wireless signal receiver;
wherein the personal safety monitoring system is configured to
detect loss of balance events; and
determine physical location correlated with detected loss of balance events and log the same.

2. The personal safety monitoring system of claim 1, wherein the personal safety monitoring system is configured to provide a notification of physical locations associated with loss of balance events.

3. The personal safety monitoring system of claim 2, wherein the notification includes a warning of danger and the notification is delivered prior to encountering and/or reencountering the physical location.

4. The personal safety monitoring system of claim 2, wherein the notification includes a warning of danger and the notification is delivered when approaching the physical location.

5. The personal safety monitoring system of claim 1, wherein the personal safety monitoring system is configured to classify the determined physical location as being a perpetual or transient danger.

6. The personal safety monitoring system of claim 1, wherein the personal safety monitoring system is configured to provide a notification of physical locations associated with loss of balance events to a third party.

7-9. (canceled)

10. The personal safety monitoring system of claim 1, wherein loss of balance events are detected based on motion sensor signals crossing a threshold value of variance.

11. The personal safety monitoring system of claim 1, the wearable device further comprising a microphone.

12. The personal safety monitoring system of claim 11, wherein loss of balance events are detected based on at least one of the microphone signals and the motion sensor signals.

13. The personal safety monitoring system of claim 1, wherein the personal safety monitoring system is configured to calculate balance recovery metrics after detected loss of balance events.

14. The personal safety monitoring system of claim 13, the balance recovery metrics comprising a balance recovery time.

15. The personal safety monitoring system of claim 1, wherein detected loss of balance events are unprompted.

16. The personal safety monitoring system of claim 1, wherein detected loss of balance events are in response to a prompt or challenge.

17. The personal safety monitoring system of claim 1, wherein the personal safety monitoring system is configured to correlate medication administration times with detected loss of balance events.

18. The personal safety monitoring system of claim 1, wherein the personal safety monitoring system is configured to correlate time of day with detected loss of balance events.

19. The personal safety monitoring system of claim 1, wherein the personal safety monitoring system is configured to correlate occurrences of a daily event with detected loss of balance events.

20. The personal safety monitoring system of claim 19, the daily event comprising at least one selected from the group consisting of a bed time, a rising time, a meal time, and a bathroom time.

21. The personal safety monitoring system of claim 1, wherein the personal safety monitoring system is configured to detect vertical movement and correlate the same with detected loss of balance events.

22. The personal safety monitoring system of claim 21, the vertical movement comprising climbing stairs.

23. The personal safety monitoring system of claim 21, the vertical movement comprising rising from a chair.

24-81. (canceled)
